(19) United States
(12) Patent Application Publication
(10) Pub. No.: US 2015/0027279 A1
(43) Pub. Date: Jan. 29, 2015

(54) Tension- adjusting tool

(71) Applicant: Edward Robert Galley, Newtonville (CA)

(72) Inventor: Edward Robert Galley, Newtonville (CA)

(73) Assignee: Galley Transport Inc., Newtonville (CA)

(21) Appl. No.: 14/121,052

(22) Filed: Jul. 25, 2014

(30) Foreign Application Priority Data
Jul. 26, 2013 (CA) 2,822,034

(51) Int. Cl. F16H 7/12; B25B 13/48

(52) U.S. Cl. CPC F16H 7/1254; B25B 13/481; F16H 2007/088
USPC 81/438

(57) ABSTRACT

A tension-adjusting tool includes a L-shaped rod composed of two segments. One segment is removably attached to a rocker on which the tensioning pulley of a diesel engine of a truck is mounted while the other segment has a tubular component in which a handle is removably accommodated. The handle has an upper portion which extends above the engine and which can be manipulated to activate the L-shaped rod in order to cause the rocker to pivot with resulting change in the pressure applied by the tensioning pulley.

### FIELD OF THE INVENTION

This invention relates to tools for use in servicing diesel engines and more particularly to a tool for adjusting the tension of a belt in a diesel engine.

### CROSS-REFERENCE TO RELATED PRIOR APPLICATION

This application claims priority pursuant to 35 USC 119 of Canadian application no. 2,822,034 filed in the Canadian Intellectual Property Office on Jul. 26, 2013 which application is herein incorporated herein by reference in its entirety.

### BACKGROUND OF THE INVENTION

Diesel engines are the conventional means for powering heavy duty trucks. The engines of such trucks consume large quantities of fuel and because of the rising cost of fuel in the last thirty years, the trucks which are powered by such engines have been modified in various ways with the object of reducing their fuel consumption. Among the modifications is the reduction of the height in the cabs of such trucks in order to reduce their aerodynamic drag.

The consequence of reduction of the height of the cabs is a reduction in the amount of smace beneath the engines of such trucks. However as the space reduces, the more difficult their engines are to work on. This is usually not a problem where the engines are serviced in a garage since the trucks can be raised by means of a hoist to provide additional space for such work. However in the case of disabled trucks beside a highway, only with considerable difficulty can their diesel engines be worked on from beneath them because of the very limited space in which to do so. In such cases, the engines must usually be worked on from above them and to gain access to many of the parts of the engine requiring service, other parts must be removed. As a result, while there is an advantage to reducing the aerodynamic drag of the cab of a truck by reducing its height there is a disadvantage in doing so and that is in the time required to service their engines and the resulting additional cost in doing so.

On a highway, a broken or damaged fan belt is often the source of trouble in a diesel engine. In many heavy duty trucks a fan belt is not readily accessible from above the engines and can only be reached with considerable inconvenience and after a significant amount of time. I have invented a tool which makes it possible to service, adjust or remove a fan belt from above a diesel engine. My tool can be used to reach a belt quickly and easily from above a diesel engine in order to provide the necessary service to the belt or to replace a damaged or broken belt with a new belt.

### SUMMARY OF THE INVENTION

Briefly, the tool of my invention comprises an L-shaped rod composed of two segments. One segment has a free end provided with means for removable attachment to a rocker to which a tensioning pulley is mounted. The other segment of my tool has a tubular component in which a handle is removably accommodated. The handle is provided to reach the tubular component from above the engine in order to cause the rocker to pivot with resulting alteration in the tensioning force applied to the belt by the tensioning pulley.

### DESCRIPTION OF THE DRAWINGS

The tool of the invention functions to adjust the tension of a belt of a diesel engine and is described in detail with reference to the accompanying drawings in which:

FIG. 1 is a perspective view of a cab of a conventional tractor trailer;

FIG. 2 is a schematic representation of the components of a conventional diesel engine;

FIG. 3 is a perspective view of the components of a diesel engine and the tension-adjusting tool of the invention;

FIGS. 4 and 5 are perspective views of the components of a diesel engine and the tension-adjusting tool showing the manner in which the tool is used; and

FIGS. 6 and 7 are schematic representations of the components of the engine and the tool in operation.

Like reference characters refer to like parts throughout the description of the drawings.

### DESCRIPTION OF PREFERRED EMBODIMENT OF THE INVENTION

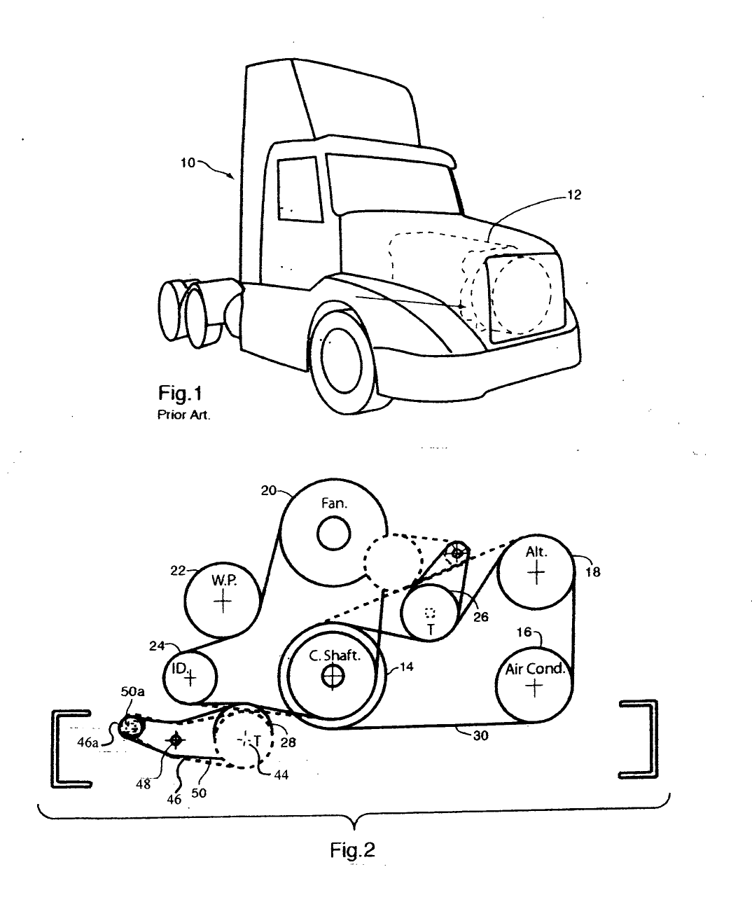

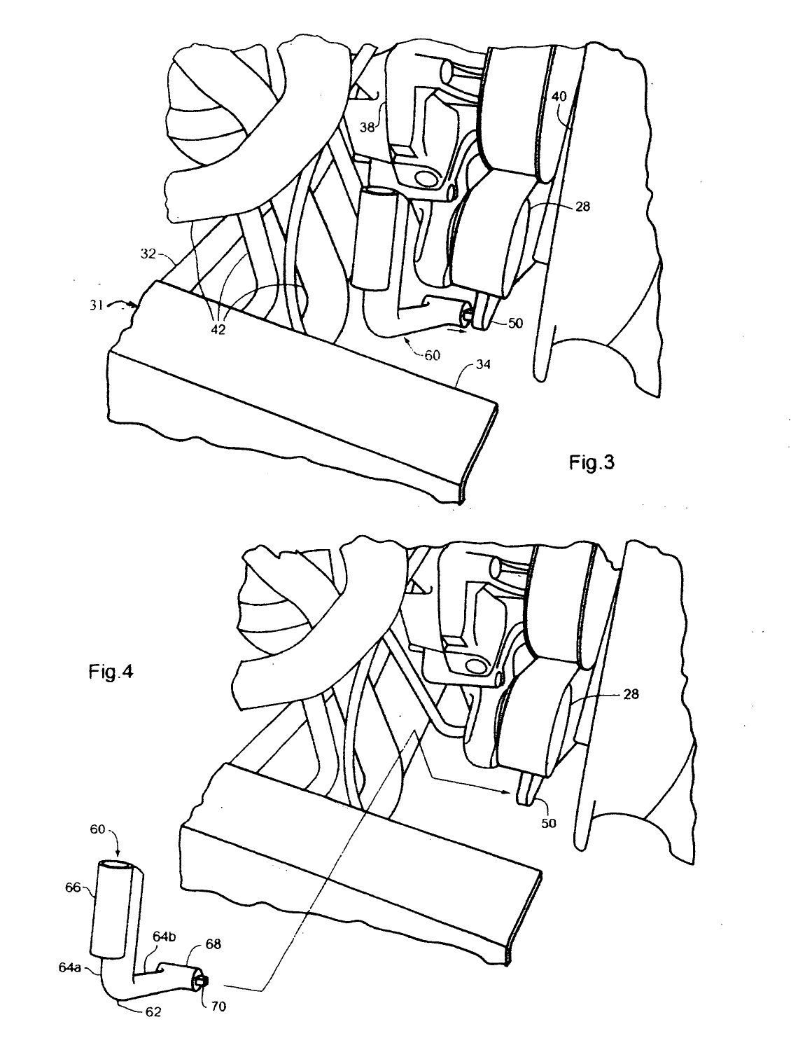

With reference to FIGS. 1 and 2, a cab, generally 10 of a tractor trailer is provided with a conventional diesel engine 12. The engine is provided with a number of pulleys: a pulley 14 for activating a crank shaft, a pulley 16 for activating an air conditioner; a pully 18 for activating an alternator; a pulley 20 for activating a fan, and a pulley 22 for activating a water pump. A pulley 24 serves as an idler while pulleys 26, 28 function to adjust the tension of belt 30.

With reference to FIG. 3, conventional components of the frame, generally 31, of the tractor trailer to which the engine is mounted include a cross-member 32 and a front rail 34. The components of the engine include water pump 38, a shroud 40 for a fan (not illustrated) and hoses, generally 42 for air, coolant and emissions. All of these components are conventional.

As illustrated in FIGS. 2 and 3, the tensioning pulley 28 is mounted for rotation at 44 adjacent to one end of a rocker 46. The rocker is pivotally mounted to the frame of the tractor trailer at 48, At one end 46a of the rocker there is a rectangular opening 50a.

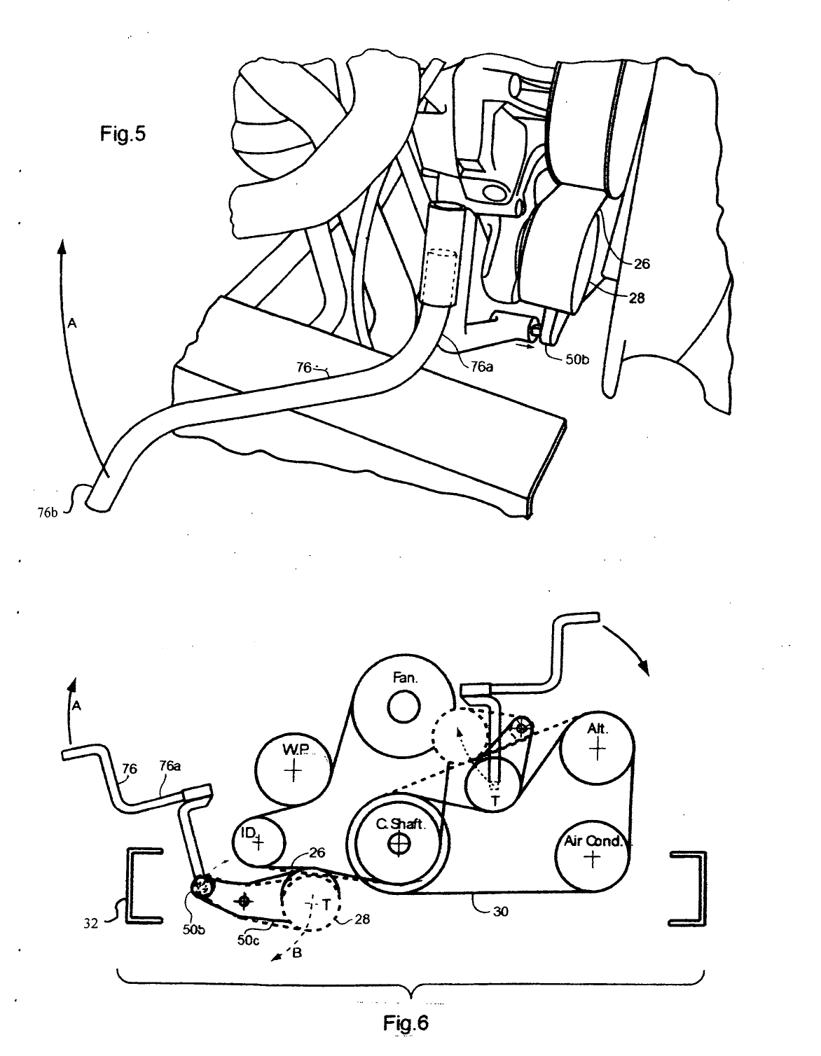

With reference to FIGS. 3 and 4, the tension-adjusting tool of the invention, generally 60 includes an L-shaped rod 62 composed of first and second segments 64a, 64b respectively. Preferably the angle between the two segments is about 90 degrees. A tube 66 is attached to the first segment while at the end of the second segment there is a cylindrical cross-member 68 which extends laterally from opposite sides of the end of the segment. A protuberance 70 extends further laterally outwardly from one side of the extension. The outer wall of the protuberance is rectangular and fits into the rectangular opening 50a of the rocker. When the protuberance is in the opening, upward or downward movement of the tension-adjusting tool causes the rocker to pivot.

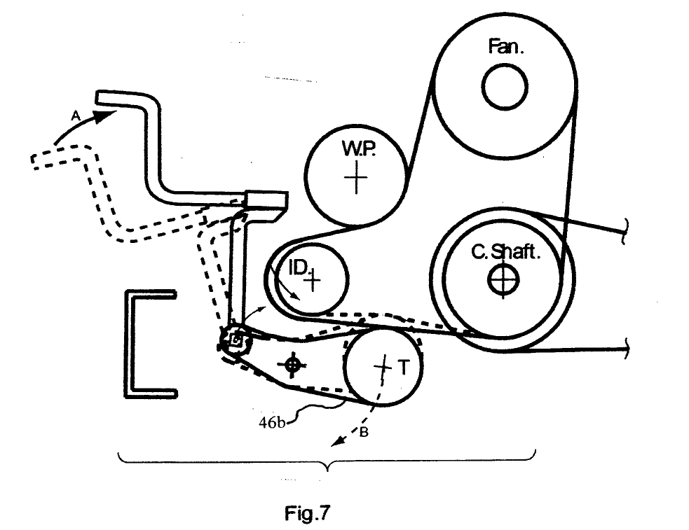

With reference to FIGS. 5-7, a generally Z-shaped handle 76 has a lower terminal portion 76a which fits into tube 66 of the tension-adjusting tool and an upper hand-held portion 76b which permits manipulation of the handle from above the diesel engine. Raising of the handle in the manner illustrated by arrow A in FIG. 7 when the lower terminal end of the handle is within tube 66 causes the end 46b of the rocker to pivot downward in the direction of broken arrow B. As the latter end of the rocker pivots downward so too does the tensioning pulley 28 with resulting reduction of the pressure of the pulley on belt 30.

By means of the handle, the pressure on the belt can be reduced sufficiently to allow the belt to be removed shoult it be worn out or damaged and to be replaced by a new undamaged belt.

In the diesel engines of most tractor trailers there is sufficient space above the rocker for a Z-shaped handle so that the subject tension-adjusting tool can be attached to the rocker and manipulated from above the diesel engine by hand. However in some cases the design of the diesel engine and the location of the rocker do not provide sufficient space for a handle in the shape of a Z in which case the shape of the handle must be changed. Similarly, the shape of the subject tension-adjusting tool in which the angle of its two segments is 90 degrees may not fit into the space adjacent to the rocker of some diesel engines in which case the angle between the two segments of the tool may have to be changed. Changes which are necessary in the shape of the handle and in the shape of the subject tool for these components to fit into the diesel engine can be easily determined empirically. The resulting tool and handle will permit the belt tensioning pulley on belt 30 to be adjusted from above the diesel engine and are within the scope of the subject invention.

The shape of protuberance 70 on the subject tension-adjusting tool may also be varied. It may be rectangular as illustrated in the drawings, or it may be hexagonal, star-shaped or other shapes. Of course, if the shape of the protuberance is varied, so too must the shape of opening 50b in the rocker in which the protuberance is received.

It will be understood, of course, that other variances and modifications can be made in the structure of the tension-adjusting tool without departing from the scope and purview of the invention as defined in the following claims. For example, a conventional socket (not illustrated) may be substituted for opening 50a in the rocker. As well, protuberance 70 can be formed either in the second segment of rod 62 as shown in the subject drawings or it can be formed on the rocker. Of course, in the latter case, an opening for receipt of the protuberance must be provided on the second segment of the rod.

I claim:

1. A tool for adjusting the tension on a belt produced by a tensioning pulley, said belt driving components of a diesel engine mounted on a frame of a motor vehicle, said tensioning pulley being located to rotate on a rocker pivotal with respect to said frame, said tension-adjusting tool including: interconnected first and second segments, said first segment being tubular while said second segment is provided with means for removable attachment to said rocker; a handle having a terminal portion adapted to be removably accommodated within said tubular first segment, said handle being of a shape such that, by manipulation of said handle from above said engine, said terminal portion can be inserted into said first segment and when so inserted, to function to cause said rocker to pivot with resulting adjustment in the pressure applied to said belt by said tensioning pulley.

2. The tension-adjusting tool of claim 1 wherein said removable attachment means is a protuberance attached to one of said second segment and said rocker, an opening being formed in the other of said second segment and said rocker, said protuberance having an outer wall which conforms to the shape of said opening such that when said protuberance is within said opening said protuberance functions to cause said rocker to pivot.

3. The tension-adjusting tool of claim 1 wherein said removable attachment means is a protuberance attached to one of said second segment and said rocker and a socket attached to the other of said second segment and said rocker, said protuberance being removably receivable in said socket and when therein functioning to cause said rocker to pivot.

4. The tension-adjusting tool of claim 1 wherein said first and second segments are integral parts of a solid rod, said first segment being tubular by virtue of a tube attached thereto in which said terminal portion is removably accommodated.

5. The tension-adjusting tool of claim 4 wherein the angle between said first and second segments is about 90 degrees.

6. A tool for adjusting the tension on a belt by a tensioning pulley, said belt driving components of a diesel engine which is mounted on a frame of a motor vehicle, said tensioning pulley being mounted to rotate on a rocker which is provided with an opening and which is pivotal relative to said frame, said tension-adjusting tool including: an L-shaped rod having first and second segments; a tube attached to said first segment; a protuberance extending outward from said second segment and having an outer wall which conforms to a shape defined by said opening such that when said protuberance is within said opening, said protuberance functions to cause said rocker to pivot with respect to said frame; a generally Z shaped handle having a hand-held upper portion for manipulation of said handle and a lower terminal portion adapted to be removably accommodated within said tube, said handle, when said hand-held portion is manipulated from above said diesel engine and said terminal portion is accommodated in said tube, causing said rocker to pivot with resulting alteration in the pressure applied to said belt by said tensioning pulley.

7. The tension-adjusting tool of claim 6 wherein said first and second segments are integral parts of a solid rod, said second segment having a tube attached thereto in which said terminal portion is removably accommodated.

8. The tension-adjusting tool of claim 7 wherein the angle between said first and second segments is about 90 degrees.
